(19) United States
(12) Patent Application Publication
(10) Pub. No.: US 2018/0089677 A1
(43) Pub. Date: Mar. 29, 2018

(54) SCALABLE CREDIT CARD SYSTEM

(71) Applicant: INTERNATIONAL BUSINESS MACHINES CORPORATION, ARMONK, NY (US)

(72) Inventors: Asmahan A. Ali, Highland, NY (US); Ali Y. Duale, Poughkeepsie, NY (US); Mustafa Y. Mah, Highland, NY (US)

(21) Appl. No.: 15/274,484

(22) Filed: Sep. 23, 2016

(51) Int. Cl. G06Q 20/40; G06Q 20/34

(52) U.S. Cl. CPC G06Q 20/409; G06Q 20/341

(57) ABSTRACT

Embodiments include method, systems and computer program products for transaction authorization. Aspects include receiving, by a processor, credit card information from a card holder, wherein the credit card information includes a credit card for the card holder. Obtaining a transaction code associated with the credit card and a set of transaction controls. Receiving, by a processor, a request for authorization for a charge on the credit card, the request for authorization including the transaction code, wherein the transaction code is provided by an individual that is not the card holder. Responsive to receiving the transaction code, analyzing the set of transaction controls to determine whether the charge is authorized and responsive to determining the charge is authorized, authorizing the charge on the credit card.

### BACKGROUND

The present disclosure relates to credit card systems and, more specifically, to methods and systems for a transaction authorization for a credit card.

Consumer credit card transactions have achieved widespread use. These transactions are performed every day over the Internet and through point of sale or banking systems. These credit card transactions are usually performed after authentication of information about the credit card holder. This can be completed via in person through a signature or on the Internet with a verification of card holder information. Typically, a credit card holder has a card issued to the holder directly for use by the holder. The credit card holder must be present at the point of sale or banking system to enact a credit card transaction.

### SUMMARY

Embodiments include a computer-implemented method for transaction authorization, the method includes receiving, by a processor, credit card information from a card holder, wherein the credit card information includes a credit card for the card holder. Obtaining a transaction code associated with the credit card and a set of transaction controls. Receiving, by a processor, a request for authorization for a charge on the credit card, the request for authorization including the transaction code, wherein the transaction code is provided by an individual that is not the card holder. Responsive to receiving the transaction code, analyzing the set of transaction controls to determine whether the charge is authorized and responsive to determining the charge is authorized, authorizing the charge on the credit card.

Embodiments include a computer system for transaction authorization, the computer system for transaction authorization having a processor, the processor configured to perform a method. The method includes receiving, by a processor, credit card information from a card holder, wherein the credit card information includes a credit card for the card holder. Obtaining a transaction code associated with the credit card and a set of transaction controls. Receiving, by a processor, a request for authorization for a charge on the credit card, the request for authorization including the transaction code, wherein the transaction code is provided by an individual that is not the card holder. Responsive to receiving the transaction code, analyzing the set of transaction controls to determine whether the charge is authorized and responsive to determining the charge is authorized, authorizing the charge on the credit card.

Embodiments also include a computer program product for transaction authorization, the computer program product including a non-transitory computer readable storage medium having computer readable program code embodied therewith. The computer readable program code including computer readable program code configured to perform a method. The method includes receiving, by a processor, credit card information from a card holder, wherein the credit card information includes a credit card for the card holder. Obtaining a transaction code associated with the credit card and a set of transaction controls. Receiving, by a processor, a request for authorization for a charge on the credit card, the request for authorization including the transaction code, wherein the transaction code is provided by an individual that is not the card holder. Responsive to receiving the transaction code, analyzing the set of transaction controls to determine whether the charge is authorized and responsive to determining the charge is authorized, authorizing the charge on the credit card.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE DRAWINGS

The subject matter which is regarded as the invention is particularly pointed out and distinctly claimed in the claims at the conclusion of the specification. The foregoing and other features and advantages of the invention are apparent from the following detailed description taken in conjunction with the accompanying drawings in which:

FIG. 1 depicts a cloud computing environment according to one or more embodiments of the present invention;

FIG. 2 depicts abstraction model layers according to one or more embodiments of the present invention;

FIG. 3 illustrates a block diagram of a computer system for use in practicing the teachings herein;

FIG. 4 illustrates a block diagram of a system for transaction authorization in accordance with one or more embodiments; and

FIG. 5 illustrates a flow diagram of a method for transaction authorization in accordance with one or more embodiments.

### DETAILED DESCRIPTION

In accordance with exemplary embodiments of the disclosure, methods, systems and computer program products for transaction authorization are provided. In one or more exemplary embodiments, methods for transaction authorization include a credit card type where the authorized user can authorize others to make purchases. The card holder or the card owner can set the spending limit for the card to an amount that can be charged to the card as well as setting the location and/or time the card can be used by others. For example, a parent can authorize one or more children to use the parent's credit card. The parent can set the limit that each child can spend, the time limit for the children to use the credit card and the location where the card can be used. The transaction authorization is done where the user does not have physical possession of the credit card. Instead, the user possesses a code that acts as a proxy for the credit card when presented to a point of sale terminal. The code is entered and then the credit card information is accessed based upon this code as well as a set of transaction controls for use of the credit card.

The present invention relates to a transaction authorization system. Currently, each credit card holder needs to have his or her own card issued to them. This forces each card holder to be physically present in the event the card holder decides to pay for another individual's expenses. In the event the card holder decides to pay for a number of individuals, each individual has to wait until the card holder is present at the point of sale system with the physical card present. The present invention allows for a card holder to delegate their power to other individuals.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

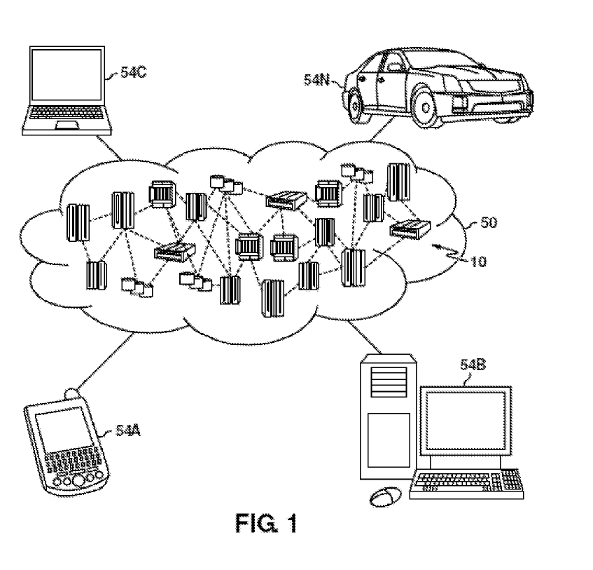

Referring now to FIG. 1, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

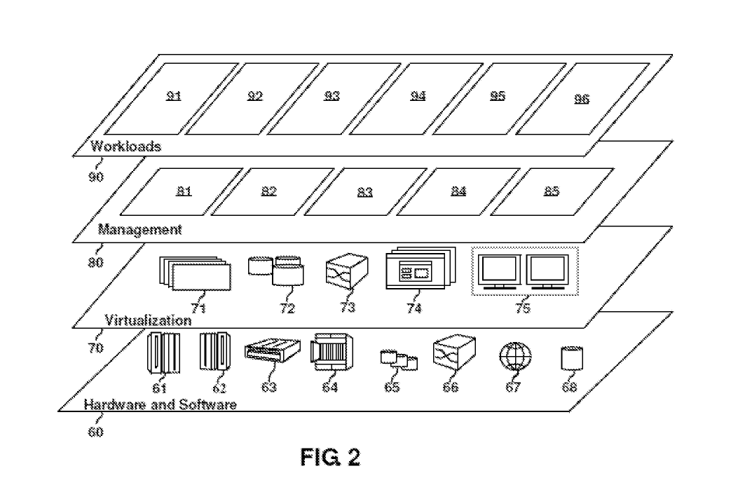

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provides pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and transaction authorization 96.

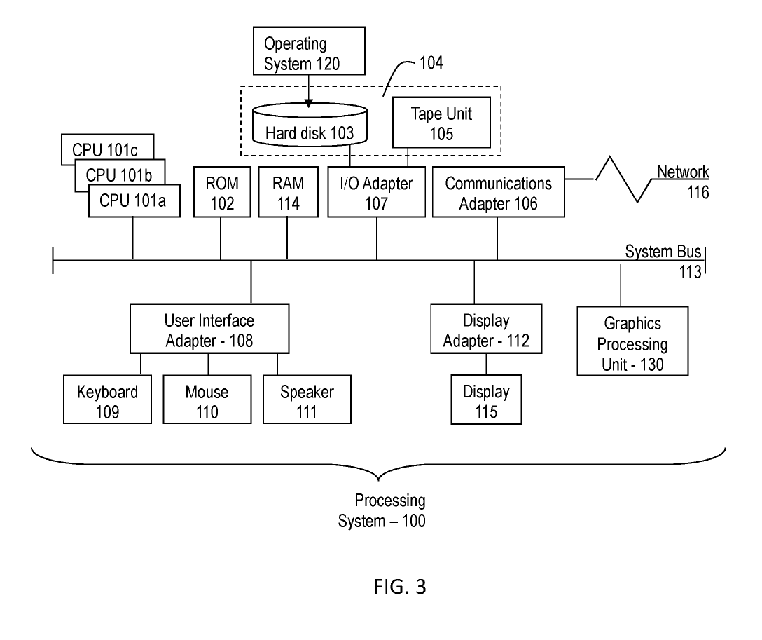

Referring to FIG. 3, there is shown an embodiment of a processing system 100 for implementing the teachings herein. In this embodiment, the system 100 has one or more central processing units (processors) 101a, 101b, 101c, etc. (collectively or generically referred to as processor(s) 101). In one or more embodiments, each processor 101 may include a reduced instruction set computer (RISC) microprocessor. Processors 101 are coupled to system memory 114 and various other components via a system bus 113. Read only memory (ROM) 102 is coupled to the system bus 113 and may include a basic input/output system (BIOS), which controls certain basic functions of system 100.

FIG. 3 further depicts an input/output (I/O) adapter 107 and a network adapter 106 coupled to the system bus 113. I/O adapter 107 may be a small computer system interface (SCSI) adapter that communicates with a hard disk 103 and/or tape storage drive 105 or any other similar component. I/O adapter 107, hard disk 103, and tape storage device 105 are collectively referred to herein as mass storage 104. Operating system 120 for execution on the processing system 100 may be stored in mass storage 104. A network adapter 106 interconnects bus 113 with an outside network 116 enabling data processing system 100 to communicate with other such systems. A screen (e.g., a display monitor) 115 is connected to system bus 113 by display adaptor 112, which may include a graphics adapter to improve the performance of graphics intensive applications and a video controller. In one embodiment, adapters 107, 106, and 112 may be connected to one or more I/O busses that are connected to system bus 113 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 113 via user interface adapter 108 and display adapter 112. A keyboard 109, mouse 110, and speaker 111 all interconnected to bus 113 via user interface adapter 108, which may include, for example, a Super I/O chip integrating multiple device adapters into a single integrated circuit.

In exemplary embodiments, the processing system 100 includes a graphics processing unit 130. Graphics processing unit 130 is a specialized electronic circuit designed to manipulate and alter memory to accelerate the creation of images in a frame buffer intended for output to a display. In general, graphics processing unit 130 is very efficient at manipulating computer graphics and image processing and has a highly parallel structure that makes it more effective than general-purpose CPUs for algorithms where processing of large blocks of data is done in parallel.

Thus, as configured in FIG. 3, the system 100 includes processing capability in the form of processors 101, storage capability including system memory 114 and mass storage 104, input means such as keyboard 109 and mouse 110, and output capability including speaker 111 and display 115. In one embodiment, a portion of system memory 114 and mass storage 104 collectively store an operating system coordinate the functions of the various components shown in FIG. 3.

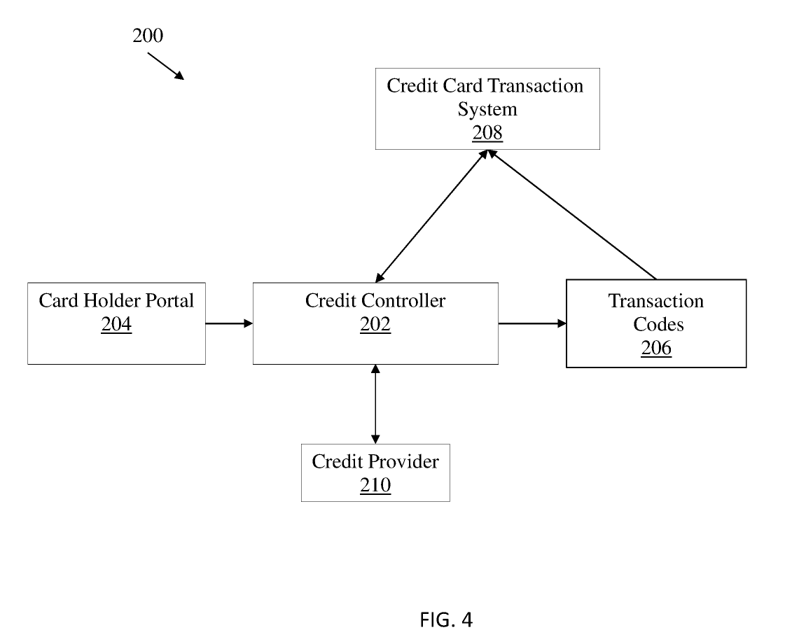

Referring to FIG. 4 there is shown a system 200 for transaction authorization according to one or more embodiments. The system 200 includes a credit controller 202, a card holder portal 204, one or more transaction codes 206, a credit provider 210, and a credit card transaction system 208.

In one or more embodiments, the credit controller 202 can be implemented on the processing system 100 found in FIG. 3. The credit controller 202 receives credit card information from a card holder through the card holder portal 204. The credit card information includes one or more credit cards of the card holder and a set of transaction controls. Once the set of transaction controls are entered, the credit controller 202 produces a transaction code 206. The transaction code 206 acts as a proxy for the credit card account and can be given to a credit card transaction system 208 for a purchase. The credit card transaction system 208 can be any system utilized by a merchant, service provider, and the like. In the event of a purchase or charge on the credit card, the transaction code 206 is entered into the credit card transaction system by, for example, a merchant and forwarded to the credit controller 202. The credit controller analyzes the set of transaction controls associated with the transaction code 206 to determine if a charge is authorized.

In one or more embodiments, the card holder portal 204 can by a web portal or a smartphone application on a card holder's smartphone.

In one or more embodiments, the individual using the transaction code to purchase items from a merchant does not have physical custody of the credit card and utilizes the transaction code 206 as a proxy for the actual credit card. The card holder can create multiple sets of transaction controls through the card holder portal 204 to obtain multiple transaction codes 206 associated with the set of transaction controls and the card holders one or more credit cards. In an embodiment, the transaction codes 206 can be associated with only one credit card or can be associated with more than one credit cards and charge authorization for the more than one credit card can be based on credit limit availability on the credit cards.

In one or more embodiments, each of the transaction codes 206 contains a set of transaction controls. The set of transaction controls defines the usage authorization for the one or more credit cards of the card holder. For example, a card holder may obtain a transaction code for a family member that defines a time, a spending limit, a location, a merchandise type, and a required identification of the family member for authorized transactions on the one or more credit cards.

In one or more embodiments, the credit controller 202 works between credit card authorization process for the credit card transaction system 208 and the credit provider 210. In one or more embodiments, the credit card transaction system 208 includes a point of sale system at a store, service center, or the like. The credit controller 202 performs authorization for credit charges before sending the charge to the credit provider 210. In one or more embodiments, the credit provider 210 is a credit card company, a bank, or any other financial institution that extends credit. The credit controller 202 is a layer between the credit card transaction system 208 and the credit provider 210 and allows a card holder to set up transaction codes 206 and transaction controls without the need to set the same transaction controls with the credit provider 210. The credit controller 202 has a faster response time than a credit provider 210 as it is card holder defined and is an intermediary between the point of sale and the credit provider.

In one or more embodiments, the card holder portal 204 can be used to identify one or more classes of transaction codes 206 for the credit card. For example, if the card holder is a parent of three children, the card holder can identify a user class as “child” and designate certain restrictions for usage of the card for this designated class that are associated with one or more transaction codes 206. The “child” transaction codes 206 can be restricted by a credit limit of $250 and restricted to purchases within a set of designated stores. Additional transaction codes can be created such as a “contractor” for any repairs done for a card holder. The class can designate a spending limit, a project time or authorization time, and an ID requirement. The “contractor” class is not user specific; instead the class can be applied to a group of individuals designated as part of the “contractor” class. Each of the transaction controls apply to the class unless modified by the card holder.

In one or more embodiments, the presence of the physical credit card or a secondary credit card tied to the card holder is not required to complete a transaction at the credit card transaction system 208. The card holder submits a set of transaction controls through the card holder portal 204 to the credit control that creates one or more transaction codes 206. The credit controller 202 analyzes the set of transaction controls associated with the transaction code 206 to determine if the card transaction is authorized and either authorizes the transaction or declines the transaction. For example, if the user has exceeded the spending limit designated in the set of transaction controls, then any credit card transactions are declined. Or if the user is purchase merchandise that is not specified in the set of transaction controls, the credit card transaction is declined. Only after all the transaction controls associated with the transaction code have been satisfied for the transaction is a credit transaction authorized.

In one or more embodiments, the card holder can modify the set of transaction controls associated with the transaction code 206 in real time without the need to contact the credit provider 210. In addition, the card holder can adjust the transaction controls for the different classes of users without the need to contact the credit provider 210. Modifications can include changes to spending limits or identification requirements for each transaction code being utilized for the credit card.

In one or more embodiments, the transaction codes 206 can be a binary number, a hexadecimal number, or a set of characters/numbers. The transaction code 206 is entered into the credit card transaction system 208 by a merchant after it is given by the individual associated with the transaction code 206, as defined by the card holder. Once the transaction code 206 is entered, it is forwarded to the credit controller 202 which analyzes the set of transaction controls associated with the transaction code 206 to determine if a charge of the credit card transaction system 208 is authorized. The transaction codes 206 are distinct from the account numbers on the credit card that is associated with the transaction code 206. Also, the binary, hexadecimal, or set of characters/numbers are utilized to obtain the account number of the credit card. The binary, hexadecimal, or set of characters/numbers can be arranged so to ease the memorization of the transaction code. For example, a 16 digit card number could be decoded with a set of characters that spell out a common word for the individual to use as a transaction code, such as “Spend” or “Teddy Bear.”

In one or more embodiments, the transaction code 206 can be a code entered into a smartphone application to receive a secondary transaction code for authorization. The secondary transaction code can be a valid authorization code for a short time period to allow an individual to complete a purchase utilizing the charge. The expiring secondary transaction code can protect from unauthorized usage of the transaction codes 206 because it is entered into the individual smartphone, via an application or a web portal, to obtain a temporary secondary transaction code that expires shortly after usage. For example, if an individual orally conveys the transaction code 206 to a merchant, a nearby customer can overhear the transaction code 206 and attempt to utilize the code at a different merchant. However, if an individual obtains a temporary secondary transaction code to utilize for each transaction, any other customer that overhears this temporary secondary transaction code will not be able to utilize the temporary secondary transaction code at another merchant.

In one or more embodiments, when a charge is declined for any reason, the card holder can be notified by any means, including but not limited to, the card holder portal 204, an email, text message, automated phone call, and the like. Upon notification, the card holder may override the set of transaction controls associated with the transaction code 206 to authorize the transaction. Alternatively, the card holder may request additional information about the charge to decide whether to override and authorize or to accept the decline of a credit card transaction system 208.

In one or more embodiments, in the event a charge is declined, the individual in possession of the transaction code can send an override request to the card holder to authorize the transaction.

In one or more embodiments, the set of transaction controls can include a spending limit associated with the transaction code 206. The spending limit can be broken down into multiple tiers with a range of dollar amounts within the tiers as well as an authorization level. For example, if the spending limit broken down into three tiers with the dollars amounts being tier 1: $0-$100, tier 2: $101-$250, and tier 3: $251+. The authorization level for tier 1 can be “authorized”, the authorization level for tier 3 can be “not authorized,” and the authorization level for tier 2 can be “card holder request.” The card holder request authorization level can send a notification to the card holder to request authorization for a charge in the dollar range of tier 2.

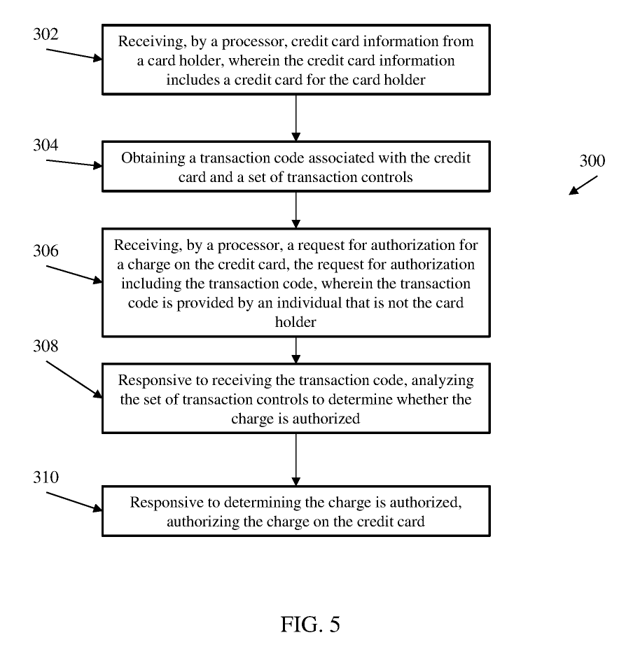

Referring now to FIG. 5 there is shown a flow diagram of a method 300 for transaction authorization according to one or more embodiments. The method 300 includes receiving, by a processor, credit card information from a card holder, wherein the credit card information includes a credit card for the card holder as shown at block 302. Next, at block 304, the method 300 includes obtaining a transaction code associated with the credit card and a set of transaction controls. At block 306, the method 300 includes receiving, by a processor, a request for authorization for a charge on the credit card, the request for authorization including the transaction code, wherein the transaction code is provided by an individual that is not the card holder. The method 300 includes responsive to receiving the transaction code, analyzing the set of transaction controls to determine whether the charge is authorized as shown at block 308. Next, at block 310, the method 300 includes responsive to determining the charge is authorized, authorizing the charge on the credit card.

Additional processes may also be included. It should be understood that the processes depicted in FIG. 5 represent illustrations, and that other processes may be added or existing processes may be removed, modified, or rearranged without departing from the scope and spirit of the present disclosure.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting-data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer-implemented method for transaction authorization, the method comprising:
receiving, by a processor, credit card information from a card holder, wherein the credit card information includes a credit card for the card holder;
obtaining a transaction code associated with the credit card and a set of transaction controls;
receiving, by a processor, a request for authorization for a charge on the credit card, the request for authorization including the transaction code, wherein the transaction code is provided by an individual that is not the card holder;
responsive to receiving the transaction code, analyzing the set of transaction controls to determine whether the charge is authorized; and
responsive to determining the charge is authorized, authorizing the charge on the credit card.

2. The method of claim 1, wherein the transaction code is a first transaction code, the set of transaction controls is a first set of transaction controls, the charge is a first charge, and the individual is a first individual, the method further comprising:
obtaining a second transaction code associated with the credit card and a second set of transaction controls;
receiving, by a processor, a request for authorization for a second charge on the credit card, the request for authorization including the second transaction code, wherein the second transaction code is provided by a second individual that is not the card holder;
responsive to receiving the second transaction code, analyzing the second set of transaction controls to determine whether the charge is authorized; and
responsive to determining the second charge is authorized, authorizing the second charge on the credit card.

3. The method of claim 1, wherein the request for authorization for the charge does not include the individual producing the credit card.

4. The method of claim 1, further comprising:
responsive to determining the charge is not authorized, sending a notification to the card holder.

5. The method of claim 4, wherein the notification to the card holder comprises a request for authorization for the charge.

6. The method of claim 1, wherein the set of transaction controls includes a spending limit for the individual.

7. The method of claim 6, wherein the spending limit for the individual comprises two or more tiers.

8. The method of claim 7, wherein the two or more tiers each include a range of dollar amounts and an authorization level associated with the range of dollar amounts.

9. The method of claim 8, wherein the authorization level comprises an authorized, a not authorized, and a card holder request.

10. The method of claim 1, wherein the set of transaction controls associated the transaction code is modifiable by the card holder in real time.

11. The method of claim 1, wherein the set of transaction controls includes at least one of a required identification necessary to authorize the charge on the credit card, a time period for when a credit card charge is authorized, and a restriction on a type of purchase that is authorized.

12. The method of claim 1, wherein the set of transaction controls includes one or more purchase locations where a credit card charge is authorized.

13. The method of claim 1, wherein the transaction code is a hexadecimal code.

14. The method of claim 1, wherein the transaction code is distinct from an account number associated with the credit card.

15. The method of claim 1, wherein the credit card information from the card holder comprises two or more credit cards, and wherein the transaction code is associated with the two or more credit cards.

16. A system for transaction authorization, the system for transaction authorization having a processor coupled to a memory, the processor configured to perform a method comprising:
receiving, by a processor, credit card information from a card holder, wherein the credit card information includes a credit card for the card holder;
obtaining a transaction code associated with the credit card and a set of transaction controls;
receiving, by a processor, a request for authorization for a charge on the credit card, the request for authorization including the transaction code, wherein the transaction code is provided by an individual that is not the card holder;
responsive to receiving the transaction code, analyzing the set of transaction controls to determine whether the charge is authorized; and
responsive to determining the charge is authorized, authorizing the charge on the credit card.

17. The system of claim 16, wherein the transaction code is a first transaction code, the set of transaction controls is a first set of transaction controls, the charge is a first charge, and the individual is a first individual, the method further comprising:
obtaining a second transaction code associated with the credit card and a second set of transaction controls;
receiving, by a processor, a request for authorization for a second charge on the credit card, the request for authorization including the second transaction code, wherein the second transaction code is provided by a second individual that is not the card holder;
responsive to receiving the second transaction code, analyzing the second set of transaction controls to determine whether the charge is authorized; and
responsive to determining the second charge is authorized, authorizing the second charge on the credit card.

18. The system of claim 16, further comprising:
responsive to determining the charge is not authorized, declining the charge on the credit card.

19. A computer program product for transaction authorization, the computer program product including a computer readable storage medium having computer readable program code embodied therewith, the computer readable program code including computer readable program code configured to perform a method, the method comprising:
receiving, by a processor, credit card information from a card holder, wherein the credit card information includes a credit card for the card holder;
obtaining a transaction code associated with the credit card and a set of transaction controls;
receiving, by a processor, a request for authorization for a charge on the credit card, the request for authorization including the transaction code, wherein the transaction code is provided by an individual that is not the card holder;
responsive to receiving the transaction code, analyzing the set of transaction controls to determine whether the charge is authorized; and
responsive to determining the charge is authorized, authorizing the charge on the credit card.

20. The computer program product of claim 19, further comprising:
responsive to determining the charge is not authorized, declining the charge on the credit card.
